(19) United States
(12) Patent Application Publication
(10) Pub. No.: US 2006/0233220 A1
(43) Pub. Date: Oct. 19, 2006

(54) Wireless telephone with spectral spread in sampled voice

(75) Inventor: Joao Martinho Coata, Sao Jose (BR)

Correspondence Address: WELSH & KATZ, LTD, 120 S RIVERSIDE PLAZA, 22ND FLOOR, CHICAGO, IL, 60606, US

(73) Assignee: Intelibras S/A, Sao Jose (BR)

(21) Appl. No.: 10/563,521

(22) PCT Filed: Jun. 29, 2004
(86) PCT No.: PCT/BR04/00107

§ 371 Date: Jan. 3, 2006

(30) Foreign Application Priority Data
Jul. 1, 2003 (BR) PI0302553-5

(51) Int. Cl. H04B 1/00

(52) U.S. Cl. 375/130

(57) ABSTRACT

A cordless telephone handset and a cordless telephone base station both comprise a transmitter unit and a receiver unit is presented whereby the communication between said handset and said base station is established over a radio link utilizing an analogue based spread spectrum communication technique whereby at the transmitter unit the analogue voice signal is sampled by means of a sample and hold unit, frequency modulated by means of a voltage controlled oscillator (VCO) and the spectrum of said modulated carrier signal is spread by a mixer through a PN sequence, which is produced by a PN sequence generator, thereby producing a spread spectrum frequency modulated carrier signal for transmission over said radio link to the receiver unit whereby at the receiver said spread and frequency modulated carrier signal is received (1) and de-spread by means of a mixer through a PN sequence which is regenerated by means of a delay locked code tracking loop (DLL) and demodulated by means of a frequency demodulator whereby at the receiver unit the analogue voice signal (5) is finally generated by means of a hold circuit and a bans pass filter.

### TECHNICAL FIELD

This patent refers to an invention and innovations introduced in the transmitter and receiver of equipment that transmit analog signals by radio frequency, applicable to any analog signal communications system by radio frequency but in particular, to wireless phones and wireless PABX, in which said patent enables a greater range of communication combined with raw material costs reduction.

This patent consist of a new concept in transmitter and receiver of analog signals called “Spectral Spread In Sampled Voice” which when used in wireless phones and wireless PABX converts them into wireless equipment with spectral spread in sampled voice, allowing them substantial superior range.

### BACKGROUND OF THE INVENTION

In relation to what is known in prior art, there are basically 4 types of wireless phones at present: analog with frequency modulation, conventional digital, digital with spectral spread, and analog with spectral spread.

Laws in several countries where analog phone with frequency modulation, and conventional digital phone is allowed, limited to a maximum transmission power much lower than what is allowed for the spectral spread phone (analog or digital), which is the case of Brazil, where maximum EIRP (effective isotropic radiated power) for an analog phone with frequency modulation is 1.25 dBm, while for systems with spectral spread, the maximum can be up to 36 dBm. The wireless phone, object of this patent, although in a different form, will use spectral spread and therefore, transmit the same power levels permitted for spectral spread phones. However, as sensitivity of wireless phone receiver proposed (using spectral spread in sampled voice) is quite close to a conventional analog phone, which is better than that of the conventional digital, the proposed phone will allow range higher than that of analog and digital conventional phones.

In digital phones with spectral spread, the voice signal is digitized before spectral spread. This provokes delays b/w the signal transmitted and received, creating the need for an echo canceling circuit at the base (part of the wireless phone that connects to the telephone line). Also, digital phones with spectral spread usually have reception sensitivity below that of analog phones. The wireless phone, object of this patent, by using transmitters and receivers in the spectral spread in sampled voice conception does not need an echo canceling circuit, which gives it considerable cost reduction and better reception sensitivity (close to that of analog phones). We can summarize that communication range obtained by the phone of this patent occurs due to the fact that transmission is done at a greater power (using spectral spread) and for keeping receiver sensitivity at levels close to those of receivers with frequency modulation.

The analog phone with spectral spread in the market has range close to that of the wireless phone of this patent but as transmission is in 100% of the time, there is high battery consumption leading to use of bigger and more expensive batteries. In addition, transmission and reception is done in different frequencies requiring two duplexers (which leads to higher costs), or using very distinct frequencies such as 900 MHz and 2.4 GHz to separate reception transmission.

### TECHNICAL PROBLEMS AND OBJECTS OF THE INVENTION

In the wireless phone, object of this patent, the audio signal transmitted is sampled and each sample is transmitted at a very short time interval, allowing the transmitter to stay at high power for a short time, increasing battery life, or allowing transmission at higher, resulting in wider range. Another advantage of the wireless phone—object of this patent is that there is no need for duplexers or the transmission of distinct bands as the system is half-duplex and the transmission frequency can be the same as of reception.

### DESCRIPTION OF DRAWING FIGURES

Objectives, advantages and other important characteristics of the invention patent can be more easily understood when read with the attached Figures:

FIG. 1 represents diagram in sections of portable wireless phone with spectral spread in sampled voice.

FIG. 2 represents a diagram in sections of the base of the wireless phone with spectral spread in sampled voice.

FIG. 3A represents a diagram in sections of the transmitter used in the wireless phone with spectral spread in sampled voice.

FIG. 3B represents a diagram of the signal transmitter used in the wireless phone with spectral spread in sampled voice.

FIG. 4A represents a diagram in sections of the receiver used in the wireless phone with spectral spread in sampled voice.

FIG. 4B represents a diagram of the signal receptor used in the wireless phone with spectral spread in sampled voice.

FIG. 5 represents an autocorrelation graph of a sequence code of maximum length equal to N chips.

FIG. 6 represents in (a) a graph of an 7-chip Pn with Tpn=7 us transmitted at every 112 us; (b) signal frequency spectrum of (a); (c) two PNs of 7 chips with Tpn=7 us transmitted every 112 us; and (d) signal frequency of spectrum (c).

### DESCRIPTION OF PREFERRED EMBODIMENTS

As can be seen in the annexed figures illustrating and integrating the descriptive report of the invention patent—“Wireless phone with Spectral Spread in Sampled Voice” in FIGS. (1) and (2), the invention is presented in a general form, including improvements introduced directly into the transmitter and receiver sections on the portable base to create a differentiated conception called “Spectral Spread in Sampled Voice”

The general conception of the wireless phone with spectral spread in sampled voice can be fully understood through transmitter sections diagram as shown in FIG. (3A), through signals transmitter diagram—FIG. (3B), showing the wave lengths obtained at each point indicated in the transmitter section diagram of FIG. (3A).

Thus, it is seen that the audio signal to be transmitted is sampled by a sample-and-hold (S/H) circuit at a sampling rate controlled by the signal frequency present at the clock input which, as example, can be about 8 kHz. In sync with the sampling signal, the pulse generator generates a square pulse whose “duty cycle” represents the relation b/w transmission time and available time for reception. The S/H signal is then multiplied by the pulses from the generator in such a manner that in the multiplier output (A) there will only be sampled audio signal during the pulse. The multiplier output signal (A) is then injected into the VCO tuning input (voltage controlled oscillator) making its output a modulated frequency carrier. The PN generator generates a pulse sequence (chips) whose amplitude can assume two levels, plus one or minus one. This PN is multiplied by the pulse generator and therefore at the multiplier (B) output there is an intermediary PN, i.e. existing only during transmission time. This signal is filtered by a band pass filter and multiplied by the modulated carrier in FM, generating a BPSK signal during the pulse duration (out of pulse time there is no carrier transmission), whose wave width will be determined by the duration of each chip once the duration of each chip is quite lower than the transmission pulse time. The filter's function is to limit the PN in band, i.e. to filter high frequency components in such a manner as to maintain the signal spread at the transmitter output within±1/Tc, where Tc is the duration of each PN chip. The output signal to be transmitted only exists during the transmission pulse of the carrier (VCO signal) and the carrier is with spectral frequency spread digitally by the PN Generator through BPSK modulation.

The general conception of the receiver in the wireless phone with spectral spread in sampled voice can be fully understood through the receiver sections diagram, as shown in FIG. (4A), and through receiver signals diagram—FIG. (4B), showing the waves obtained in simulation at several indicated points on the sections diagram of the receiver—FIG. (4A).

Thus, the receiver has an internal PN generator that generates three sequences, PNE, PNL and PNi. This last one in sync with PN within the signal received called PNrx. This synchronism is done by the circuit called DLL (delay locked loop). PNE (E for Early) and PNL (L for late) are exact replicas of PNi, but PNE is advanced by half a chip in relation to PNi, and PNL late by half a chip in relation to PNi.

Functioning of the DLL is easily found in literatures on spectral spread systems. However, to allow for better understanding of how the receiver with spectral spread in sampled voice functions, it will be explained in detail. It is important to point out that nothing impedes receiver synchronism with spectral spread in sampled voice when used in wireless phone—object of this patent, by another type of synchronism circuit.

DLL functioning is based on behavior of the PNs autocorrelation function. PN is a maximum sequence code whose autocorrelation presents the behaviors shown in FIG. (5). The PN autocorrelation, when |τ|>1 chip (phase difference greater than a chip), is always constant with value equal to minus one. When τ=0 (phase signal), autocorrelation value is maximum and equal to the total number of PN chips. When −1<τ<1, i.e. when the difference of phase b/w signals is within the range of plus one or less one chip, the autocorrelation value varies linearly due to τ. It is also observed in the FIG. (5) that the autocorrelation value is the same for τ=½ chip and for τ=−½ chip. For that reason the PNi generator also generates PNE and PNL signals. When PNrx is in phase with PNi, PNrx is delayed by half chip (τ=−½ chip) in relation to PNE and advanced by half chip (τ=½ chip) in relation to PNL. This is the only condition (considering the range −1<τ<1) in which the output levels of the two bands pass filters of the DLL present the same output level. It is also the DLL stabilization condition, i.e. the DDL condition it should be in when the receiver is ready for reception. This condition is commonly known as lock in PLL (hase locked loop) circuit analogy.

When PNrx is not in phase with PNi but the phase difference phase is within more or less one chip, this means that PNrx is either less dephased from PNE or more dephased from PNL, or otherwise. That, therefore, means that the output band pass filter levels of the DLL will be different and at the output of the adder there will be a signal of error that will increase or decrease the frequency of the VCO clock, advancing or delaying PNi, PNE and PNL in relation to PNrx to force correlation b/w PNrx and PNL equal to correlation b/w PNrx and PNE (PNE advanced by ½ chip and PNL delayed by 1/2 chip, both in relation to PNrx) and when that happens, the lock state is reached, the band pass filters output level of the DLL shall have the same value, generating an error signal equal to zero. The DLL will act as if in lock and will not try to put PNrx in phase with PNi. In that case, what took place is a false DLL lock. To know if the lock is real or false, verify correlation b/w PNrx and PNi. When the lock is real, correlation is maximum and band pass filter output level of the despreader is maximum. When the lock is false, it is minimum and the filter output is minimum.

As soon as the receiver is connected, despreader output shows a voltage level that varies according to the degree of correlation b/w PNrx and PNi. As the communication channel, at first, introduces an unknown delay at PNrx, it is not possible at first to determine the difference in phase b/w PNrx and PNi. When the dephasing b/w two signals exceeds the range by more or less one chip, correlation b/w the two signals is minimum and the despreader output is minimum. When dephasing is zero, correlation b/w these signals is maximum and the output level is maximum. If the difference in phase b/w signals is of more or less ½ chip, the correlation value b/w the signals is of 50% the difference b/w minimum and maximum correlation. That means that the despreader output level will also be half the difference b/w the greater and the lower output level. This level is called voltage threshold (Vt), and applies to a voltage exactly equal to this one at the input reference of the voltage comparator. The other input of the comparator will receive output signal from the despreader. Thus, when dephasing b/w PNrx and PNi exceeds the range of more or less ½ chip, the comparator input levels is less than Vt and the output voltage of the comparator stays at low level. When dephasing b/w PNrx and PNi is within the range of more or less ½ chip, the comparator input level is greater or equal to Vt and the output voltage of the comparator goes to high level (one). The great issue now is how to force the system for the dephasing b/w PNrx and PNi to stay within the range of more or less ½ chip for the DLL to reach lock state. The solution was to create a delay of one chip in PNi, PNL and PNE in every sampling while comparator output is zero. Thus, when dephasing b/w PNrx and PNi is of various chips, the PN generator will be reducing this dephasing by one and one chip every sampling period, until reaching dephasing within range of more ort less ½ chip. When that occurs, the output level of the tension comparator goes to high level and the PN generator stops creating one-chip delays. At that moment, DLL starts to act in VCO frequency until lock state is reached, i.e. until the phase difference b/w PNrx and PNi is kept next to zero.

Three distinct states of the receptor can be defined: acquisition, tracking and lock. In sequence of receptor functioning, the 1^{st} state is acquisition, the state of reception start, when dephasing b/w PNrx and PNi exceeds range of more or less ½ chip, the PN generator is creating one chip delays every sampling period and output voltage of comparator is zero. Tracking occurs next when dephasing b/w PNrx and PNi is within more or less ½ chip, comparator output goes to high and PN generator stops one chip delay. Lock comes next and then PNi follows within given limitations, PNrx phase variations to keep dephasing b/w these signals close to zero. In this last stage, receiver is ready to receive valid info. As soon as it enters lock at despreader output, carrier is received in FM as BPSK modulation responsible for spectral spread was removed at PNi multiplication. At output of despreader there is a pulsated carrier, with each pulse containing different frequency proportional to audio signal transmitted Applying then this signal to FM demodulator, we have its output with pulses of varying amplitude with input carrier frequency as shown in FIG. (4B). This signal is then sampled by a sync signal removed from the information on zero dephasing b/w PNrx and PNi, information present at the output of the detector involving the despreader output. The output signal of the Sample and Hold is then filtered and the audio restored.

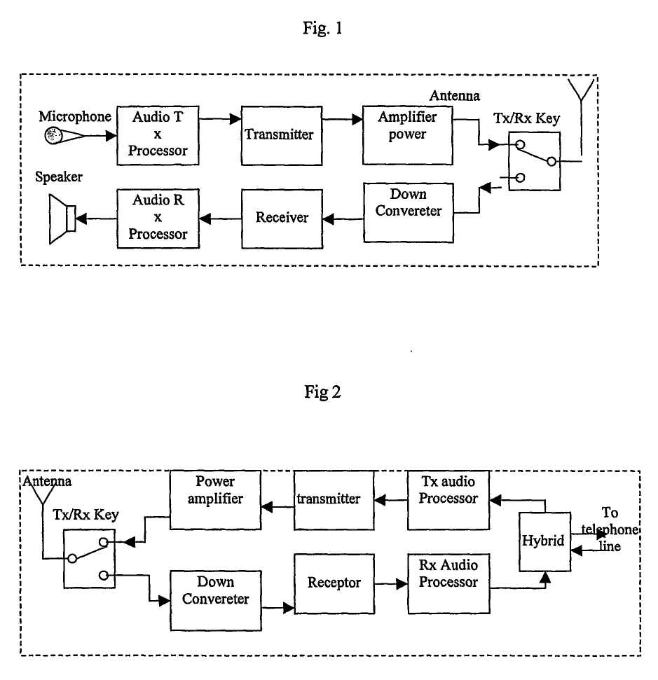

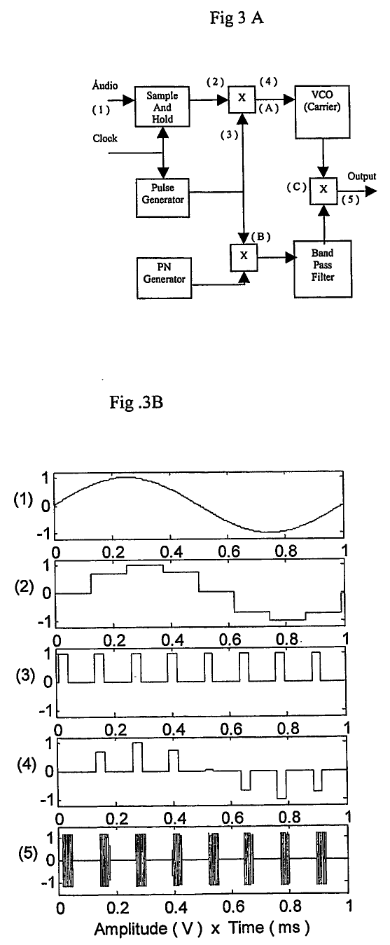

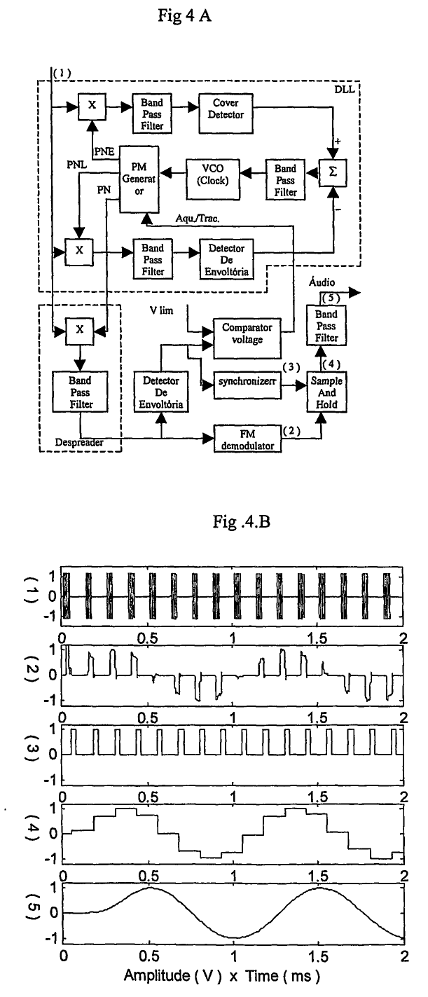

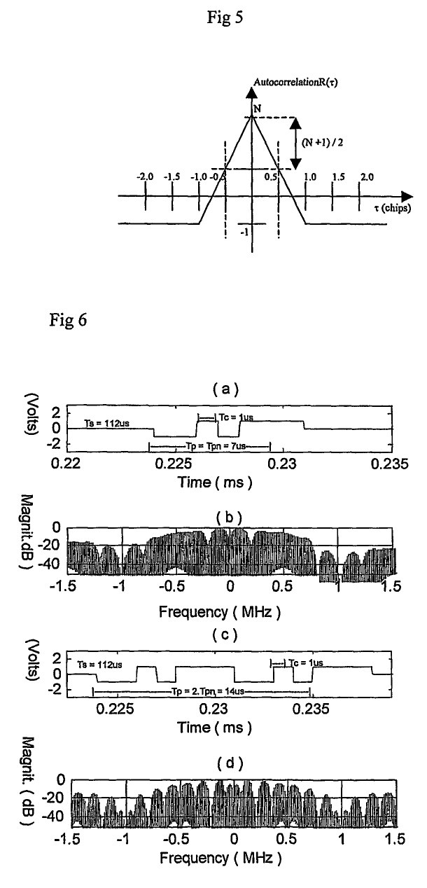

The functioning of the wireless phone as a whole can be easily understood in FIGS. 1 and 2 and the explanations that follow. It is important to point out that the different conception proposed by this patent for transmitter and receiver sections with communication synchronism b/w base and portable, i.e. portable only transmits when the base is receiving and vice versa.

On the portable, as shown in FIG. (1), voice is converted to electrical signal by mic. The Tx audio processors receives the signal and processes as a common analog phone, i.e. amplifies, adds pre-emphasis due to FM, limits frequency band through band pass filtering and compresses compounder part that transmits for noise reduction and sends signal to transmitter with spectral sampled voice spread. The output signal of the transmitter goes to the power amplifier, which simply amplifies the RF signal to suitable transmission level and sends it to Tx/Rx key, which during the transmission connects the antenna to output and during reception, connects antenna to down converter input.

RF signal transmitted by base reaches portable's antenna, which through Tx/Rx, directs it to down converter. The down converter amplifies this signal with the low noise amp., converts through frequency beat known as intermediary frequency or simply FI and limits its amplitude in such manner to keep constant output. The signal is then delivered to receiver with spectral spread is in sampled voice. The receiver delivers the restored voice signal to the Rx audio processors, which amplifies, adds Deenphase (due to FM modulation) and expands (compounder part acting in reception to reduce noise). Then the signal is delivered to the speaker to be heard by user.

On the base, as shown in FIG. (2), the voice signal from the phone line enters the hybrid, circuit which transforms two-way communication into one and vice-versa, which directs signal to Tx audio processor, which delivers processed sampled voice to the spectral spreader transmitter. The RF signal from the transmitter will be sent to the power amp. For the suitable level increase and deliver to Tx/Rx key, which at that moment will be at Tx position. Finally, through Tx/Rx, TF signal reaches antenna, which will transmit to portable.

The RF signal transmitted by portable reaches base antenna and through Tx/Rx, is directed to the down converter. The output from it is delivered improved to receiver. The receiver delivers the restored voice signal to Rx audio processor. Rx audio processor sends the processed signal to the hybrid which directs most of it to the phone line and a small part of same signal to the Tx processor which returns the signal to the portable together with signal from the line, allowing the user to hear in lower volume his own voice. As time delay of return signal in relation to signal arriving is in hundreds of micro seconds (because of clock frequency of transmitter being at 8 kHz), it is not noticed by the user and there is no need for an echo circuit usually built with DSP (Digital Signal Processor).

There is a relation b/w transmission time (Tp) and the total duration of PN (Tpn) for power distribution of transmitted signal to be kept as (sine (x)/x)², This relation shall be Tp>2Tpn. If this relation is not maintained, there will be higher power concentration in some specific frequencies. This goes against one of the greatest advantages of spectral spread, which is to reduce spectral power density. FIG. (6) shows transmitter output signals in the domains of time and frequency being (6a) and (6b) when Tp=Tpn, which escapes the rule mentioned above and (6c) and (6d) when Tp=2Tpn which obeys the abovementioned rule. It is seen that the corresponding spectrum, as shown in item (d) of FIG. (6) shows the form (sine(x)/x)², and has maximum spectral density lower than item (b) FIG. (6).

Brazilian norm regulating the use of spectral spread system is annexed to resolution 305, of Jul. 26, 2002. According to it, maximum transmission power shall be seen under 3 aspects: maximum peak power of the transmitter must not exceed one watt (30 dBm); maximum EIRP shall not exceed four watts (36 dBm); and peak power density in any range of 3 KHz during any interval of time of continuous transmission, shall not be higher than 8 dBm.

As demonstration of the transmitter and receiver potential with spectral spreader in sampled voice proposed, applied to a wireless phone called “Wireless Telephone Equipment with Spectral Spread in Sampled Voice”, object of this patent, a system was simulated (transmitter and receiver) with the following parameters: band width of transmitted signal of 1.1 MHz, PN sequence chips rate of 550.96 Mcps. Transmission time of 54.45 micro secs, reception time of 68.97 micro-secs, voice sampling period—123.42 micro-secs, PN sequence length of 15 chips, max. sequence PN, two pulse transmission PNs, despreader filter bandwidth—73 KHz, maximum carrier deviation—18 kHz and processing gain—12 dB. The result of the simulation showed that it would be possible to transmit a peak power of 25.3 dBm respecting all Brazilian standard limits. It also showed that receiver sensitivity was only 7 dB worse than that of a conventional analog FM receiver. Considering a 3 dBi antenna, max. EIRP will be 31.3 dB while the analog wireless phone of 900 MHz band, maximum EIRP allowed is −1.25 dBm, i.e. this system allows transmission by 32.55 dB more. As there was degradation of sensitivity of 7 dB, it can be easily concluded that this system allowed improvement of 32.55 dB—7 dB, i.e. 25.55 dB. Considering free space propagation, it can be concluded that this system (transmitter and receiver) when included in a wireless phone, as shown in FIGS. (1) and (2) to make up the “Wireless Telephone Equipment with Spectral Spread in Sampled Voice”, object of this patent, allows for achieving communication b/w Base and Portable 18.9 times greater than analog phones with frequency modulation.

1. “WIRELESS TELEPHONE EQUIPMENT WITH SPECTRAL SPREAD IN SAMPLED VOICE”, characterized for being composed of base and portable (handset), being that both use transmitters and receivers with the “Spectral Spread in Sampled Voice” concept whose diagrams in sections and wave forms are shown in FIGS. (3A), (3B), (4A) and (4B), and that present diagrams of the portable set and base as shown in FIGS. (1) and (2) respectively, and because they use transmitter and receiver under the “Spectral Spread in Sampled voice” concept, allow reduction in battery consumption and discard the need to operate in distinct bands for transmission and reception in relation to wireless telephone using spectral spread in analog voice, and that for not digitizing voice presents the advantage of not needing analog/digital converters, level quantifier circuits, generating considerable reduction in costs and for allowing small time delays in transmission and reception discards use of echo canceling circuits, as used by digital phones which spread or not the frequency spectrum, allowing for raw material costs reduction.

2. “WIRELESS TELEPHONE EQUIPMENT WITH SPECTRAL SPREAD IN SAMPLED VOICE” according to claim in 1, characterized by a transmitter which allows its application in any transmission equipment of analog signals by radio, and that consists of sampling the signal to be transmitted through Sample-and-Hold (S/H), limiting the duration of each sample to the transmission pulse duration and making them modulate in one carrier frequency during the transmission pulse, which is simultaneously modulated in phase by PN sequence that promotes spectral spread of transmitted signal in direct sequence, which presents delay in hundreds of micro-secs, quite shorter than that caused by transmitters that digitize voice, and therefore allowing the manufacturing of wireless phones and PABX without echo canceling circuits and for their transmitting in short interval allow turning reception off for the user to receive signals in the same frequency, eliminating the need for duplexers and two distinct bands for transmission/reception in a given equipment, and which shall operate in sync with the receiver under the concept of “Spectral Spread in Sampled Voice”, and that in conjunction with the “Spectral Spread in Sampled Voice” enables greater communication range under the laws in force regulating and allowing greater power for equipment using spectral spread transmission.

3. “WIRELESS TELEPHONE EQUIPMENT WITH SPECTRAL SPREAD IN SAMPLED VOICE” with receiver having an internal PN generator that generates three sequences, PNE, PNL and PNi. This last one in sync with PN within the signal received called PNrx. This synchronism is done by the circuit called DLL (delay locked loop); PNE (E for Early) and PNL (L for late) are exact replicas of PNi, but PNE is advanced by half a chip in relation to PNi, and PNL late by half a chip in relation to PNi.; DLL functioning is based on behavior of the PNs autocorrelation function. PN is a maximum sequence code whose autocorrelation presents the behaviors shown in FIG. (5). The PN autocorrelation, when |τ|>1 chip (phase difference greater than a chip), is always constant with value equal to minus one. When τ=0 (phase signal), autocorrelation value is maximum and equal to the total number of PN chips. When −1<τ<1, i.e. when the difference of phase b/w signals is within the range of plus one or less one chip, the autocorrelation value varies linearly due to τ; it is also observed in the figure that the autocorrelation value is the same for τ=½ chip and for τ=−½ chip. For that reason the PNi generator also generates PNE and PNL signals. When PNrx is in phase with PNi, PNrx is delayed by half chip (τ=−½ chip) in relation to PNE and advanced by half chip (τ=½ chip) in relation to PNL. This is the only condition (considering the range −1<τ<1) in which the output levels of the two band pass filters of the DLL present the same output level. It is also the DLL stabilization condition, i.e. the DDL condition it should be in when the receiver is ready for reception. This condition is commonly known as lock in PLL circuit analogy (phase locked loop); When PNrx is not in phase with PNi but the phase difference phase is within more or less one chip, this means that PNrx is either less dephased from PNE or more dephased from PNL, or otherwise. That, therefore, means that the output band pass filter levels of the DLL will be different and at the output of the adder there will be a signal of error that will increase or decrease the frequency of the VCO clock, advancing or delaying PNi, PNE and PNL in relation to PNrx to force correlation b/w PNrx and PNL to be equal to correlation b/w PNrx and PNE (PNE advanced by ½ chip and PNL delayed by ½ chip, both in relation to PNrx) and when that happens, the lock state is reached; when the phase difference between PNix and PNi is greater than one chip, the band pass filters output level of the DLL shall have the same value, generating an error signal equal to zero; The DLL will acts as if in lock and will not try to put PNrx in phase with PNi; In that case, what took place is a false DLL lock. To know if the lock is real or false, verify correlation b/w PNrx and PNi. When the lock is real, correlation is maximum and band pass filter output level of the despreader is maximum; When the lock is false, it is minimum and the filter output is minimum; As soon as the receiver is connected, despreader output shows a tension level that varies according to the degree of correlation b/w PNrx and PNi; As the communication channel, at first, introduces an unknown delay at PNrx, it is not possible at first to determine the difference in phase b/w PNrx and PNi; when the dephasing b/w two signals exceeds the range by more or less one chip, correlation b/w the two signals is minimum and the despreader output is minimum; When dephasing is zero, correlation b/w these signals is maximum and the output level is maximum; If the difference in phase b/w signals is of more or less ½ chip, the correlation value b/w the signals is of 50% the difference b/w minimum and maximum correlation; That means that the despreader output level will also be half the difference b/w the greater and the lower output level; This level is called voltage threshold (Vt) and applies to a voltage exactly equal to this one at the reference input of the voltage comparator; The other input of the comparator will receive output signal from the despreader; Thus, when dephasing b/w PNrx and PNi exceeds the range of more or less ½ chip, the comparator input levels is less than Vt and the output voltage of the comparator stays at low level; When dephasing b/w PNrx and PNi is within the range of more or less ½ chip, the comparator input level is greater or equal to Vt and the output level of the comparator goes to high level (one); there is delay of one chip in PNi, PNL and PNE every sampling period while the output voltage comparator is “zero” ;we must force the system for the dephasing b/w PNrx and PNi to stay within the range of more or less ½ chip for the DLL to reach lock state; Thus, when dephasing b/w PNrx and PNi is of various chips and one and one chip every sampling period until reaching dephasing within range of more or less ½ chip; When that occurs, the output level of the tension comparator goes to high level and the PN generator stops creating one chip delays; At that moment, DLL starts to act in VCO frequency until lock state is reached, i.e.; until the phase difference b/w PNrx and PNi is kept next to zero; three distinct states of the receptor can be defined: acquisition, tracking and lock; In sequence of receptor functioning, the 1^{st} state is acquisition, the state of reception start, when dephasing b/w PNrx and PNi exceeds range or more or less ½ chip, the PN generator creating one chip delays every sampling period and output voltage of comparator zero; Tracking occurs next when dephasing b/w PNrx and within more or less ½ chip, comparator output goes to high and PN generator stops one chip delay. Lock comes next and then PNi accompanies within given limitations, PNrx phase variations to keep dephasing b/w these signals close to zero; allowing the functioning of receptions of the “Wireless Telephone Equipment with Spectral Spread in Sampled Voice” according to claim 1, which is characterized by receptor with new concept called “Spectral Spread in Sampled Voice” shown o FIGS. (4A) and (4B), which allows for its use in any equipment of analog signal reception via radio and that consists of receiving a signal from transmitter from claim 2, eliminate spectral spread through correlation of signal received with PN sequence generated internally, which is synchronized with the signal received through DLL circuit (Delay Locked Loop) or any other synchronism circuit based on autocorrelation of PN sequences and that at despreader circuit output presents a carrier modulated in frequency by the information samples transmitted and modulated in amplitude by the transmission pulse, and which demodulates this carrier in FM, obtaining ate demodulator output pulses whose amplitude vary due to transmitted information level, and which through such pulses, using a sampling circuit and a band pass filter, restores transmitted analog signal through transmitter, and from zero dephasing information b/w PN sequence of signal received and PN sequence generated locally, the detector circuit involving the despreader output and the synchronizer, obtaining clock signal necessary to sample, and which allows a sensitivity of about 7 dB worse than a conventional FM receiver as shown in the simulation presented in this patent request limited to example purposes only, which should operate in sync with the transmitter of claim 2, and operating in unison with the transmitter set of claim 2 allows for greater communication range.
